(19) United States
(12) Patent Application Publication
(10) Pub. No.: US 2008/0241343 A1
(43) Pub. Date: Oct. 2, 2008

(54) Lupin food product base and processes

(75) Inventors: Pat R. Mitchell, Stockton, CA (US); Khalid R. Shammet, Tracy, CA (US)

Correspondence Address: Robert Charles Hill, 235 Montgomery Street #821, San Francisco, CA, 94104, US

(73) Assignee: California Natural Products

(21) Appl. No.: 11/729,334

(22) Filed: Mar. 28, 2007

(51) Int. Cl. A23L 1/20

(52) U.S. Cl. 426/634

(57) ABSTRACT

A food making process comprises starting with Lupin legumes with minimum levels of alkaloids, dehulling the Lupin legumes to produce split seed kernels, mixing the split seed kernels with hot water to hydrate them into a slurry, grinding the slurry to blend and smooth it into a product base, cooking the product base to achieve a particular flavor and aroma consistent with a target food product, cooling the product base to stop cooking, and further processing the product base into a target food product like soups and beverages. In particular, the Lupinus Angustifolius variety produces the best results, but other sweet lupin varieties can be used if they have been leached of their bitter tasting alkaloids. The products produced have high levels of protein, vitamins, and other nutritional values. Both batch and continuous processes are possible.

### FIELD OF THE PRESENT INVENTION

The present invention relates to food products and manufacturing processes for soups and beverages, and in particular to a nondairy food base from Lupin legumes.

### BACKGROUND

Cow's milk is a universally popular beverage because of its good taste, and its protein, calcium, vitamin, fat, and lactose nutritional values. Thirty years ago, various nondairy beverage substitutes for milk began to be marketed. The demand for these products came from consumers who could not digest or tolerate milk for some reason, but nevertheless wanted a drink that had similar nutritional and functional properties. Some of the problems with drinking milk were its need for refrigeration, short shelf life, dairy allergies (milk is a class-1 allergen), lactose intolerance, other negative health results, and philosophical reasons.

One of the first non-dairy substitute beverages that was a commercial success was soy milk. Soy milk is made by grinding and heating soy beans, removing the fibrous okara (soy pulp), clarifying, and pasteurizing into a soy base. Sweeteners, salt and flavors are normally added to the soy base to make a finished beverage. If the object is to mimic milk, then calcium and vitamins A and D are added. Soy is naturally high in protein, so the nutritional profile is similar to milk by adding the sweetener, calcium and vitamins. But some of the disadvantages of soy milk include a strong “beany” flavor that is objectionable to many people, digestibility, soy allergies (soy is a class 1 allergen), low naturally occurring levels of calcium and vitamins A and D, it's not a whole grain beverage, it's low in fiber; and not very functional in cooking recipes.

Rice milk was another non-dairy beverage that became popular soon after soy milk did. Rice milk is made by cooking the rice, adding enzymes, and filtering to yield a rice base. The rice base is naturally sweet, so sweetener does not need to be added. Salt and flavors are usually added to the rice base to make a finished beverage that tastes good. When the object is to mimic milk, then calcium, oil, and vitamins A and D are added. Fortunately, rice is hypoallergenic. So the allergen issue that is prevalent with cow's milk and soy milk, is not an issue with rice milk. Rice is low in naturally occurring proteins, calcium, and vitamins A and D, it's not very functional in recipes, and it has a low fiber content.

According to the general definition in Wikipedia, grain milk is a milk substitute made from hydrolyzed grain or from flour. Grain milk can be made from oats, spelt, rice, rye and einkorn wheat. Grain milk looks very similar to cow's milk. It has a lower protein content and a higher carbohydrate content than cow's milk. Just as cow's milk is often fortified with Vitamin D, which it naturally lacks, grain milks may have calcium and some vitamins (especially cobalamin) added to them. Cobalamin is produced exclusively by microorganisms: bacteria, fungus and algae. Higher plants and animals are unable to produce it. In lupin milk, cobalamin has been found in larger quantities. Grain milk is low in saturated fat and contains no lactose, which is beneficial for those who are lactose intolerant. Grain milk also lacks casein, making it suitable for vegans and people with milk allergies. Flavored grain milk can come in plain, vanilla, chocolate or a variety of other flavors. Like unflavored grain milk, it is often available with added nutrients.

Lupins are cultivated as forage and grain legumes. Three Mediterranean species of lupin, Lupinus Angustifolius (Blue Lupin), Lupinus albus (White Lupin) and Lupinus luteus (Yellow Lupin) are cultivated for livestock and poultry feed and for human consumption. The Andean Lupin Lupinus mutabilis and the Mediterranean L. albus, L. Angustifolius and L. hirsutus (these varieties are known locally as altramuz in Spain and Argentina) are also edible after soaking the seeds for some days in salted water. These lupins are referred to as sweet lupins because they contain smaller amounts of toxic alkaloids than the bitter varieties. Both sweet and bitter lupins in feed can cause livestock poisoning.

### SUMMARY OF THE PRESENT INVENTION

Briefly, a food process embodiment of the present invention comprises starting with Lupin legumes with minimum levels of alkaloids, dehulling the Lupin legumes to produce split seed kernels, mixing the split seed kernels with hot water to hydrate them into a slurry, grinding the slurry to blend and smooth it into a product base, cooking the product base to achieve a particular flavor and aroma consistent with a target food product, cooling the product base to stop cooking, and further processing the product base into a target food product like soups and beverages. In particular, the Lupinus Angustifolius variety produces the best results, but other sweet lupin varieties can be used if they have been leached of their bitter tasting alkaloids. The products produced have high levels of protein, vitamins, and other nutritional values. Both batch and continuous processes are possible.

An advantage of the present invention is a beverage base is provided that is high in naturally occurring fiber, protein, and calcium.

Another advantage of the present invention is a beverage base is provided that has a low carbohydrate content and therefore a very low glycemic index, a pleasant flavor, functional nutritional applications, and satiety properties that can produce a full-feeling.

The above summary of the present invention is not intended to represent each disclosed embodiment, or every aspect, of the present invention. Other aspects and example embodiments are provided in the figures and the detailed description that follow.

### BRIEF DESCRIPTION OF THE DRAWINGS

The present invention may be more completely understood in consideration of the following detailed description of various embodiments of the present invention in connection with the accompanying drawings, in which:

FIG. 1 is a flowchart diagram of batch process embodiment of the present invention for making a Lupin base; and

FIG. 2 is a flowchart diagram of continuous process embodiment of the present invention for making a Lupin base.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention as defined by the appended claims.

### DETAILED DESCRIPTION

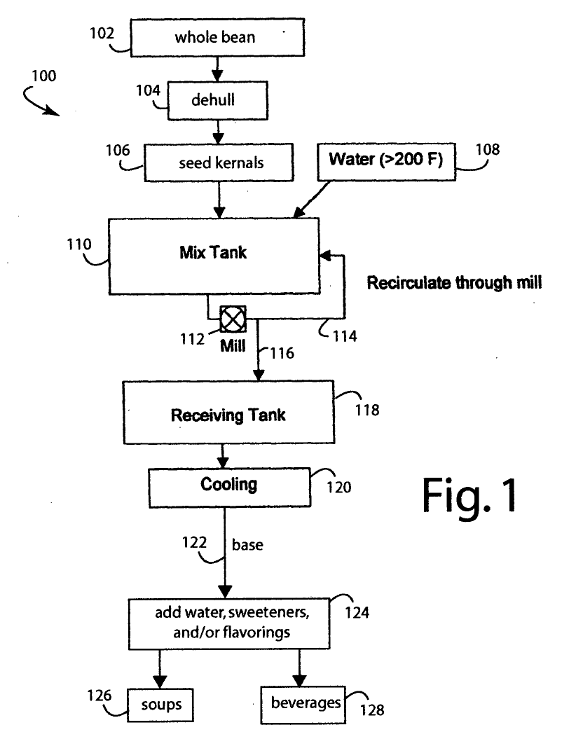

FIG. 1 represents a batch process embodiment of the present invention, and is referred to herein by the general reference numeral 100. Process 100 begins with whole-bean Lupinus Angustifolius (Blue Lupin) legume 102. Other varieties of lupins, e.g., White Lupin and Yellow Lupin, are much higher in alkaloids, and that makes them too bitter tasting and unsuitable in this application. But, if these higher amounts of alkaloids could be economically removed, then some of the other varieties of lupins could be suitable as well in this application. For example, the Andean Lupin, Lupinus mutabilis, and the Mediterranean Lupin albus, Lupin Angustifolius, and Lupin hirsutus, are edible if the seeds are soaked first for many days in salted water to leach out the alkaloids. These lupins are referred to as “sweet lupins” because they have smaller amounts of the toxic alkaloids than do the bitter varieties.

A step 104 dehulls the beans to yield the seed kernels. Usually, the shells are discarded, as they have not demonstrated a nutritional usefulness other than being ground up and used as a dietary fiber supplement. A quantity of dehulled beans 106 is added to very hot water 108 (>200° F.) in a mixing tank 110. The mixture ratio must be kept within a range of ratios, from 83% water and 17% beans, to as dilute as 91% water and 9% beans. The percentage of water to beans going into the mixing tank 110 is adjusted within such range to best maximize processing efficiency by reducing yield losses, and still be able to maintain process flowability. A defoaming agent is added as needed to control foaming in the mixing tank 110. The lupin mixture, or slurry, is cooked at 175-210° F. for 5-20 minutes, e.g., in a hot steam jacketed tank. Higher and lower cooking temperatures than those specified here have been observed to adversely impact the texture, flavor, and aroma of the finished beverage.

The cooked lupins and water are pumped through a wet mill 112. A lupin slurry 114 is re-circulated through the wet mill 112 for a minimum of ten minutes, or until all the lupin beans are fine ground for a smooth texture. A lupin base 116 is drawn into a receiving tank 118, and is cooled in a step 120 to below 50° F. before further processing. An enzymatic process employing various types of enzymes with high sheer, can subsequently be applied to lower the lupin base's viscosity and provide a smoother texture.

Cooling 120 produces a base product 122 to which water, sweeteners, and/or flavorings can be added in a step 124. Possible commercial products include packaging into soups 126 and beverages 128.

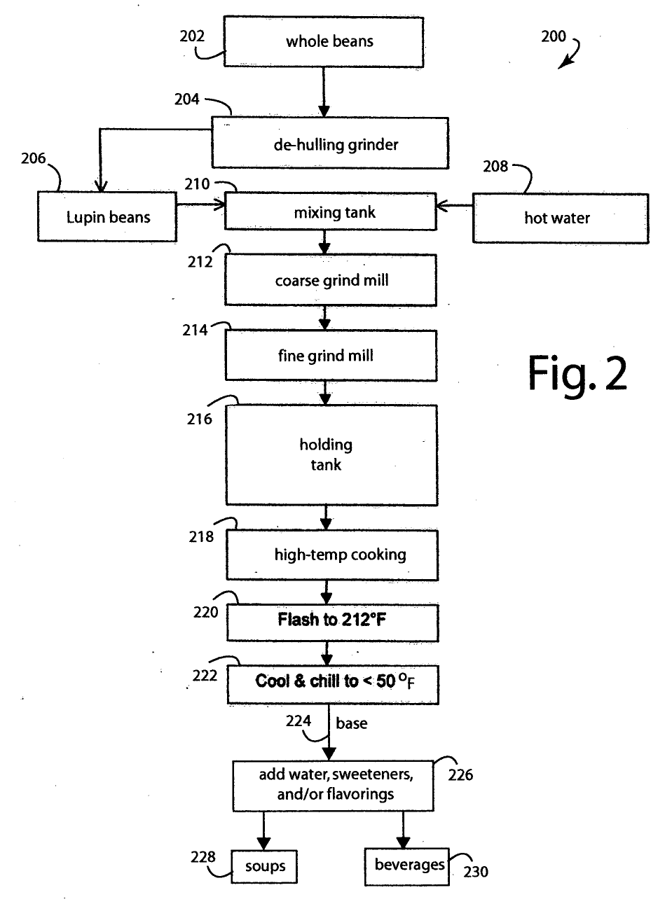

FIG. 2 represents a continuous process embodiment of the present invention for making lupin base for soups and beverages, and is referred to herein by the general reference numeral 200. Process 200 begins with a whole-bean Lupinus Angustifolius (Blue Lupin) legume 202. A step 204 dehulls and splits the beans, e.g., by grinding the beans with a roller mill/aspirator to loosen and separate the shell/coat from the seed. A de-hulled split-kernel feed 206 and a continuous hot water flow 208 are poured to a mixing tank 210. In one embodiment, the split-kernel feed 206 is set to a rate of 17-70 pounds per minute of tourmas (beans), and hot water flow 208 is heated to 160-205° F. before being added at the rate of 150-350 pounds per minute.

The solids to water mixing rates will be in a range of 5-20% because the lupin cell wall material from the cotyledons (seed leaf) has a very high hydration capacity (7-8 fold). The hold time in the mix tank 210 is 20-45 seconds. The beans are cooked 5-25 minutes to soften the kernel for grinding into finer particles, which makes a smoother product, and gives the desired flavor and aroma. A blended slurry from mixing tank 210 is passed through a first, coarse grind mill 212, then through a second, fine grind mill 214. Typical mills are run at 3,600 rpm. The finely ground, smooth slurry is then sent to a holding tank 216. The product is held in the holding tank 216 at temperatures of 185-200° F. for 2-20 minutes, depending on the target product being produced.

A steam flash 218 is used for high temperature cooking at 195-300° F. for 2-10 seconds. The product base is then sent to a 212° F. holding tank 220. A heat exchanger 222 cools the product base to less than 50° F. before further processing. A finished base 224 can be mixed with water, sweeteners, and/or flavorings in a step 226, e.g., for making soups 228 and beverages 230.

In one batch method embodiment of the present invention, whole lupin seeds are dehulled and a slurry is made. About 12,750 pounds of 200° F. water are mixed with 2,250 pounds of dehulled lupin seeds in a steam jacketed tank. The lupin slurry is cooked for ten minutes at 195° F. Such cooking prepares the lupin seed for milling and reduces the beany flavor present in raw lupin seeds. After cooking, the slurry is repeatedly circulated through a BOSTON SHEAR PUMP wet mill for ten minutes. Such wet mill is used to grind the lupin seeds into a uniform concentrate suitable for further processing, e.g., into soups and protein beverages.

In another continuous process embodiment of the present invention, whole-seed lupin legumes (Lupin angustifolius) are dehulled are split. The seed kernals are dispensed at twenty pounds per minute with a two hundred pound per minute flow of hot water at 180° F. to mix in a feed tank. The mix is agitated and held at least thirty seconds before proceeding to a first mill. For example, a perforated disc mill, such as made by FRYMA, can be operated at 3600 RPM to pulverize and macerate the seed kernels in the coarse slurry into particles less than two millimeters in diameter. A second mill, e.g., a FRYMA colloid mill, operating at 3600 RPM shears and grinds the lupin seed particles. A well dispensed, blended slurry is sent to a holding tank to stand for twenty minutes at 180° F. This time and temperature hold helps remove a beany flavor present in the legume. A steam injector heater is used to heat the slurry for two seconds at 285° F. Such will improve the shelf life of the final product, and will help eliminate any “off” flavors associated with the bean. The product is then flashed to 212° F. and can then be used immediately or cooled to less than 40° F. and stored for later processing.

The resulting lupin base is a creamy, yellow liquid with a pleasant nutty flavor and a desirable mouthfeel. There typically is no beaniness or bitterness associated with the base. The lupin base has 88.2% moisture, 4.8% protein, 1% crude fat, 0.3% ash, 0.3% crude fiber, and 5.4% carbohydrates of which 2.8% is dietary fiber. The pH of the base in tests was 5.7 with a 5.4 BRIX. Product applications, drinks, beverages, and soups have properties which can be put to use in a stabilization system.

While the present invention has been described with reference to several particular example embodiments, those skilled in the art will recognize that many changes may be made thereto without departing from the spirit and scope of the present invention, which is set forth in the following claims.

1. A food making process, comprising:
inputting Lupin legumes with minimum levels of alkaloids;
dehulling said Lupin legumes to produce split seed kernels;
mixing said split seed kernels with hot water to hydrate them into a slurry;
grinding said slurry to blend and smooth it into a product base;
cooking said product base to achieve a particular flavor and aroma consistent with a target food product;
cooling said product base to stop cooking; and
further processing said product base into said target food product.

2. The process of claim 1, wherein the Lupin legume used in the step of inputting is the Lupinus Angustifolius variety.

3. The process of claim 1, wherein the Lupin legume used is a sweet lupin variety which has been processed to leach it of its alkaloids.

4. The process of claim 1, wherein the step of further processing includes adding at least one of water, flavorings, and sweeteners consistent with producing said target food product.

5. The process of claim 1, wherein the step of grinding is part of a batch process that includes using a grinding mill that recirculates its output into a mixing tank until a particular consistency is achieved.

6. The process of claim 1, wherein the step of grinding is part of a continuous process that includes using successive coarse and fine grinding mills that together continuously product a particular product-base consistency.

7. The process of claim 1, wherein the step of cooking includes using a steam flash.

8. The product of the process of claim 1.

9. A food making process, comprising:
dehulling whole lupin seeds mixing a lupin slurry from about 12,750 pounds of 200° F. water to 2,250 pounds of dehulled lupin seeds in a steam jacketed tank;
cooking said lupin slurry for about ten minutes at about 195° F. to prepare the lupin seed for milling and to reduce any beany flavor present in raw lupin seeds;
after cooking, repeatedly circulated cooked lupin slurry through a BOSTON SHEAR PUMP wet mill for ten minutes to grind the lupin seeds into a uniform concentrate suitable for further processing into soups and protein beverages.

10. A food making process, comprising:
dehulling and splitting whole-seed Lupin angustifolius into seed kernals;
dispensing said seed kernals at about twenty pounds per minute with about two hundred pound per minute of hot water at 180° F. to mix into a feed tank;
agitating the mix and holding it at least thirty seconds;
grinding in a perforated disc mill to macerate the seed kernels in a coarse slurry into particles less than two millimeters in diameter;
grinding in a FRYMA colloid mill to shear and reduce the lupin seed particles into a well dispensed, blended slurry;
keeping said blended slurry in a holding tank to stand for twenty minutes at 180° F.;
wherein the time and temperature of holding helps remove any beany flavor present;
heating said blended slurry with steam injector heater for about two seconds at 285° F. to improve the shelf life of a final product, and help eliminate any “off” flavors;
flashing a product to 212° F. for immediate use or cooling to less than 40° F. and storing for later processing.

11. The product of the process of claim 10, wherein a resulting lupin base is a creamy, yellow liquid with a nutty flavor and a particular mouthfeel, and with no beaniness or bitterness associated with the base, and wherein a lupin base has 88.2% moisture, 4.8% protein, 1% crude fat, 0.3% ash, 0.3% crude fiber, and 5.4% carbohydrates of which 2.8% is dietary fiber, and wherein the pH of said base is about 5.7 with a 5.4 BRIX.
